(19) United States
(12) Patent Application Publication
(10) Pub. No.: US 2026/0330520 A1
(43) Pub. Date: Oct. 22, 2026

(54) USING ARTIFICIAL INTELLIGENCE TO MAP DATA SCHEMAS

(71) Applicant: Syndic8 DMS, LLC, Boston, MA (US)

(72) Inventors: Steven Crombie, North Attleborough, MA (US); Joseph Dinardo, Boston, MA (US); Michael Jaskelevicus, South Boston, MA (US)

(73) Assignee: Syndic8 DMS, LLC, Boston, MA (US)

(21) Appl. No.: 19/484,566

(22) PCT Filed: May 24, 2024
(86) PCT No.: PCT/US2024/031059

§ 371 Date: Nov. 14, 2025

Related U.S. Application Data
(60) Provisional application No. 63/469,230, filed on May 26, 2023.

(51) Int. Cl. G06Q 30/0601

(52) U.S. Cl. CPC G06Q 30/0613

(57) ABSTRACT

Transferring product data to a third party includes obtaining modifications to a schema of the third party, adjusting mappings between the schema of the third party data and an intermediary schema containing data corresponding to the product data based on the modifications by first matching fields of the intermediary schema with fields of the third party schema that are an exact match and then, for remaining unmatched fields of the third party schema, determining a best match between fields of the intermediary schema and the third party schema and estimating an accuracy of the best match using empirical calculations and an artificial intelligence algorithm and choosing a mapping having a highest estimate of accuracy, and providing data from the intermediary schema to the third party schema according to the mappings following adjusting the mappings. The artificial intelligence algorithm may use a term frequency-inverse document frequency algorithm.

### CROSS-REFERENCE TO RELATED APPLICATIONS

This application claims priority to U.S. provisional patent application No. 63/469,230, filed on May 26, 2023, which is incorporated by reference herein.

### TECHNICAL FIELD

This application relates to using artificial intelligence to map data schemas and more particularly to using artificial intelligence to map data schemas containing fields that are not an exact match.

### BACKGROUND

A product vendor may sell the products in both brick-and-mortar retail outlets and on one or more e-commerce Web sites that are operated by an e-commerce vendor specializing in selling products to consumers on the Internet. The product vendor may also provide product data to other third parties, such as backend users, data repositories, mobile applications, enterprise resource planning platforms, accounting software, shipping platforms, logistics platforms, purchase order software, etc. A product vendor that is providing product data to a third party needs to provide specific data that is required by the third party. The data requirements may be specified using a schema and may be defined in spreadsheet form (a template) or in a definition file in a specific format, such as a JSON format or an XML format. A template may be a spreadsheet which has a static set of column headers pertaining to various product attributes that a product vendor provides. In addition to headers (fields) that are required, templates may also contain content requirements, such as a list of valid values for a given field.

In some instances, a product vendor may provide the same or similar product data to different third parties (e.g., sell the same products on different e-commerce Web sites). The required set and format of data attributes used by one third party may vary greatly from the required set and format of data attributes used by another third party, even, for example, in instances where different third parties, such as different e-commerce sites, are working with the same products. Moreover, schemas for third parties sites may change over time. For example, an e-commerce vendor could increase the specificity of the e-commerce vendor schema (and thus increasing the number of data fields) by imposing additional data requirements. The increased specificity may be the result of gradual changes in consumer buying, where consumers have an increasing need for more detail about products to aid in purchase decision than would have been sufficient with less data in the past. For example, in the past a consumer may have compared televisions based on a handful of attributes (for instance, size, brand, and resolution), while a consumer today may require a many more attributes to enable a purchase decision (pixel density, refresh rate, frame size, etc.). The need for additional data may also stem from increased competition-saturated markets make product differentiation difficult for consumers. E-commerce vendors may respond by increasing the amount of information available to consumers, which in turn requires that product vendors provide additional information to e-commerce vendors.

### SUMMARY OF THE INVENTION

According to the system described herein, transferring product data to a third party includes obtaining modifications to a schema of the third party, adjusting mappings between the schema of the third party data and an intermediary schema containing data corresponding to the product data based on the modifications by first matching fields of the intermediary schema with fields of the third party schema that are an exact match and then, for remaining unmatched fields of the third party schema, determining a best match between fields of the intermediary schema and the third party schema and estimating an accuracy of the best match using empirical calculations and an artificial intelligence algorithm and choosing a mapping having a highest estimate of accuracy, and providing data from the intermediary schema to the third party schema according to the mappings following adjusting the mappings. The empirical calculations may use at least one rules-based algorithm to find a best match between fields of the intermediary schema and fields of the third party schema and to estimate an accuracy thereof. The at least one rules-based algorithm may be a bag-of-words algorithm and/or a Levenshtein distance algorithm. The artificial intelligence algorithm may use a term frequency-inverse document frequency algorithm to find the best match between fields of the intermediary schema and fields of the third party schema and to estimate the accuracy of the best match. Transferring product data to a third party may also include, prior to providing the data from the intermediary schema to the third party schema, presenting a user with a screen indicating the mappings. The screen may include controls that allow the user to change the mappings. The user may use the controls to approve or reject suggested mappings provided on the screen. The user may be provided with a recommendation to add at least one new field to the intermediary schema that is mapped to a field of the third party schema. The user may use the controls on the screen to enter new schema information and mappings therefor. Transferring product data to a third party may also include, after providing the data from the intermediary schema to the third party schema, presenting the user with a screen indicating any data that may be missing and showing data that is to be provided for the third party schema. Previously confirmed mappings may be used to train the artificial intelligence algorithm. The artificial intelligence algorithm may be trained periodically. A first portion of data corresponding to the confirmed mappings may be used to train the artificial intelligence algorithm and a second, remaining, portion of the data corresponding to the confirmed mappings may be used to validate the artificial intelligence algorithm. The first portion may be 80% and the second portion may be 20%. Transferring product data to a third party may also include, after providing the data from the intermediary schema to the third party schema, exporting data corresponding to the intermediary schema and mapping information. Data that is exported may be provided in a JSON format. Data that is exported may provide audit information. The third party may be an e-commerce vendor and data that is provided from the intermediary schema to the third party schema may be displayed on a Web site of the e-commerce vendor.

According further to the system described herein, a non-transitory computer readable medium contains software that transfers product data to a third party. The software includes executable code that obtains modifications to a schema of the third party, executable code that adjusts mappings between the schema of the third party data and an intermediary schema containing data corresponding to the product data based on the modifications by first matching fields of the intermediary schema with fields of the third party schema that are an exact match and then, for remaining unmatched fields of the third party schema, determining a best match between fields of the intermediary schema and the third party schema and estimating an accuracy of the best match using empirical calculations and an artificial intelligence algorithm and choosing a mapping having a highest estimate of accuracy, and executable code that provides data from the intermediary schema to the third party schema according to the mappings following adjusting the mappings. The third party may be an e-commerce vendor and data that is provided from the intermediary schema to the third party schema may be displayed on a Web site of the e-commerce vendor.

The system described herein may be used to align disjointed schemas, denormalized data structures (meta fields), JSON file maps, and reference tables rapidly, in support of data transformation, storage, and transmission in e-commerce. The system described herein aligns schemas by programmatically retrieving definition files, whether stored locally or provided over computer networks using Application Programming Interfaces (or similar). The definition files contain fields within a schema, metadata describing the fields, and may also include the type of data that may be stored in a given field. The system described herein compares fields between schemas, matching fields using probabilistic analysis based on naming conventions or content and suggests matchings by mapping one field to another (or possibly many-to-one or one-to-many). The system described herein then generates updated definition files for the newly aligned schema, which may be used to dynamically update data and/or update one-to many software instances reliant on the schema.

The system described herein enhances the speed of data transformations between product vendors and third parties, such as e-commerce vendors. The system described herein enables the rapid ingestion of third party data requirements (e.g., e-commerce vendor schema), the valid values for a given data field and matching of requirements with source data storage (an intermediary schema). The system described herein generates a rapid outbound data mapping, as well as data preflight to determine data suitability and correctness to transmit to a third party based on requirements. This system described herein also forms a foundation for using artificial intelligence to match schema fields.

The schemas may be stored in databases, either relational or non-relational. The system described herein may take a hybrid approach to storing data in both a relational and non-relational fashion, offering a blend of both. The schemas produced by the system described herein may store information in JSON format, which is designed to be linked to a rigid relational schema, for example in a MySQL database. A JSON file format may be used as the file structure to allow for information to be easily exported and imported into the system. JSON format data integrates with SQL databases in a relatively easy fashion and creates an ability to define import formats for required information.

The system described herein overcomes disadvantages of an inherently reactionary adjustment to data mappings when third party data requirements change. The system described herein enables dynamically expanding and realigning a database schema to reflect changes made to a third party data schema. The enhancements provided by the system described herein enable users to rapidly map third party data schemas. The system described herein also enables artificial intelligence algorithms to be developed over an intermediary schema, and a data dictionary to be created of a repository of information across many different and possibly unrelated third parties, such as different e-commerce vendors.

The system described herein provides a mechanism for reuse of mapping in a building-block fashion, so as to reduce additional rework when changes occur. For example, if a first product vendor and a second product vendor have mapped data into an intermediary schema, and both of the product vendors then transmit data to an e-commerce vendor that previously required two fields of data but is updated to require a third data field, then using the system described herein, the mapping between the intermediary schema and the schema of e-commerce vendor is updated and, in so doing, the mappings for both product vendors is updated. The system described herein may also highlight deficiencies in the data of the product vendors if the data does not include the information necessary to populate the third required data field.

The system described herein also provides templates to facilitate field level mappings, reference table lookups, valid value translations, expandable function-based transformations and data formatting. The system described herein may also handle language and currency transformations based on third party destination language and currency requirements independent of field level mappings to allow faster mappings across geographic regions. The system described herein is reactive to allow artificial intelligence algorithms to automatically match destination data requirements with a highest correlation against a plurality of third party data schemas.

The system described herein provides for the management of product data in connection with third parties that use the product data, such as an e-commerce vendor that sells products on an e-commerce Web site, where third party data schemas may be defined per product category (or subcategory). Some subcategories may inherit components of a parent category. For instance, Hiking Shoes may be a subcategory of Footwear, and may inherit an attribute of Upper Material, but not an attribute of Heel Height. Inheritance of attributes facilitates organizing, deduplicating, and mapping schemas. The system described herein is designed to be extensible by nature, such that new categories or subcategories may arbitrarily added. Note that, as e-commerce continues to expand, a larger emphasis is placed on categories and sub-categories, which facilitates applying pre-defined filters upon first logging into an e-commerce Web site. For example, it may be possible to find all books by selecting a “books” filter on an e-commerce Web site that sells books and other products.

An advantage of the system described herein is the ability to utilize metatags and matchings between a variety of destinations, source mappings, external connections, and external destinations and requirements thereof. The system described herein allows rapid expansion of maps and matches across e-commerce vendor schema by creating an intermediary schema that can provide data for different e-commerce vendors. The system described herein is designed to programmatically fetch e-commerce vendor schemas to capture changes on a scheduled basis.

The system described herein also supports a user manually creating or supplementing an intermediary schema. A user specifies or adds a third party (e.g., an e-commerce vendor) and then specifies a product category (or sub-category) that the user wishes to define. The user then adds fields and data which correspond to fields and data of the third party data schema. The user can flag a variety of metadata about each field, for instance whether a particular field is required or recommended, and if the field has a predefined list of valid values for the data, similar to a pick list of acceptable data. If the third party provides a schema in the form of a spreadsheet, a template may be uploaded and the system described herein may parse all fields and field metadata automatically from the template.

Once a third party schema has been defined, the system described herein aligns the third party schema with an intermediary schema using a sequence of processes that provide decreasing levels of precision in an attempt to match fields, until a suitable field match is found. For instance, if a name of a field in the third party schema exactly matches a name of a field in the intermediary schema, the system described herein matches the two fields automatically. If the names are similar, but not an exact match, the system described herein may suggest the fields to be matched and provide an estimation of the accuracy of the match. A best-fit matching also lays the foundation for artificial intelligence analysis, where the system described herein can use the actual values of data stored in various fields in an attempt to derive a valid map between the schemas. The internal artificial intelligence matching rules uses previously matched schema fields to continually learn and improve the matches as more schemas are mapped.

To enhance the speed at which matching is generated, a recommendation based matching algorithm is provided. If an exact match is not found, normalization of words to follow a bag-of-words model and a Levenshtein distance model are applied. Subsequently, artificial intelligence matching algorithms are then applied to find the best overall match for each given field. The same set of matching rules may also be applied to convert product data to populate the intermediary schema.

The system described herein may host an artificial intelligence application within the intermediary schema in order to allow for an artificial intelligent algorithm to train using the intermediary schema. The artificial intelligence (AI) algorithm may use a TF-IDF (term frequency-inverse document frequency) algorithm, where the AI is trained using previous schema structures that have been established and built upon from the recommendation match that is currently in place. TF-IDF algorithms measure the statistical relevance of a word within a collection of other words and documents. The TF-IDF algorithm allows using term frequency to make recommendation matches between terms in the schemas, which allows for multiple mapping points scenarios to learn and dramatically improve mapping logic quality and speed. Increasing existing mappings improves the accuracy of subsequent mappings.

### BRIEF DESCRIPTION OF DRAWINGS

Embodiments of the system are described with reference to the several figures of the drawings, noted as follows.

FIG. 1 shows a table used an e-commerce vendor to facilitate selling products on the Internet according to the system described herein.

FIG. 2A is schematic diagram illustrating a relationship between a product vendor, an intermediary, and third party according to the system described herein.

FIG. 2B is schematic diagram illustrating third party data having different possible uses according to the system described herein.

FIG. 3 is a flow diagram illustrating processing performed in connection with retrieving and handling changes or additions to a third party schema according to the system described herein.

FIG. 4 is a flow diagram illustrating processing performed in connection with matching fields of an intermediary schema and a third party schema according to the system described herein.

FIG. 5 shows a screen used for providing suggestions to a user for schema alignment according to the system described herein.

FIG. 6 shows a screen used to provide preflight data to a user according to the system described herein.

FIG. 7 illustrates a view of products on an e-commerce vendor Web site based on product data mapped to an e-commerce vendor schema according to the system described herein.

### DETAILED DESCRIPTION OF VARIOUS EMBODIMENTS

The system described herein uses empirical matching and artificial intelligence (AI) to align disjointed schemas used by third parties, such as e-commerce vendors. Schemas of third parties are first obtained by programmatically retrieving definition files, whether stored locally or provided over computer networks using Application Programming Interfaces (APIs), or similar. The definition files contain fields within a schema corresponding to categories and subcategories of products, metadata describing the fields, specific attributes/data of the products, and may also include the type of data that may be stored in a given field. Empirical calculations (e.g., exact match and approximation calculations) and artificial intelligence are used to compare fields of schemas containing the product attributes (product information of a product vendor) with fields of schemas of a third party to match fields using probabilistic analysis based on naming conventions or content and to map one field to another (or possibly many-to-one or one-to-many). An updated mapping for newly aligned schema may be generated and then used.

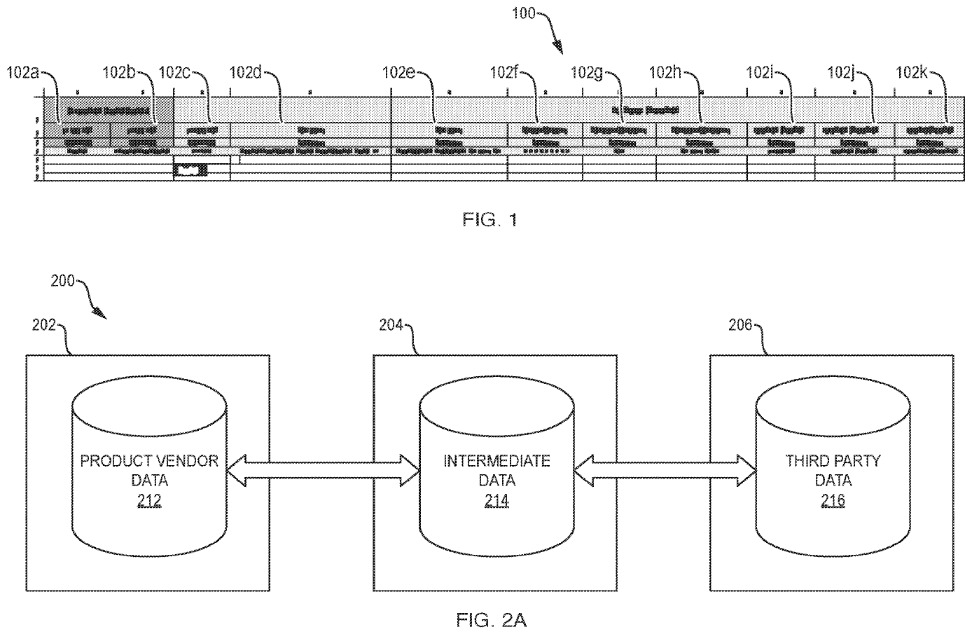

Referring to FIG. 1, a table 100 illustrates data used by an e-commerce vendor to facilitate selling products on the Internet. Note that, although the invention is illustrated herein using an e-commerce vendor, the invention is not so restricted. The invention may be used with any third party having a third party schema containing product data, such as backend users, data repositories, mobile applications, enterprise resource planning platforms, accounting software, shipping platforms, logistics platforms, purchase order software, etc. The table 100 represents an e-commerce vendor schema used by the e-commerce vendor to populate fields used in connection with a Web site that sells products. The table 100 includes a plurality of columns 102a-102k that each represent a specific data field (e.g., size, color, etc.) for a product being sold on the Internet. Each row of the table 100 corresponds to a specific product and contains data (attributes) for the specific product. In an embodiment herein, each of the fields/columns represents a category or a subcategory that correspond to products being sold on the Internet. Note that many categories and subcategories may apply to some, but not all, products. For example, footwear products may have attributes corresponding to heel height, upper material, etc. However, the attributes of heel height and upper material would not be used for electronics products. Similarly, electronics products may have an attribute for power source that would not be used for footwear. However, both footwear and electronics may use an attribute corresponding to color. In some instances, data used for currency conversion and language translations is also provided. In some, cases, subcategories may inherit one or more attributes from a parent category. For example, hiking shoes may be a subcategory of footwear, and may inherit the attribute of upper material, but not inherit the attribute of heel height.

Some data elements (i.e., categories and subcategories) may be required for specific products to sell on the Internet. For example, for clothing products, size data may be required. Other data elements may be optional, such as gender data for clothing. Other data elements may be conditionally required. For example, data indicating a number of buttons may only be required for clothing having buttons and may not otherwise be used. The table 100 may also be associated with metadata, which may be stored separately or stored with the table 100. The metadata may indicate characteristics of the data such as whether data for particular fields (categories and subcategories) are required, optional, or conditionally required. The metadata may also indicate a type/format for certain data. For example, a number of buttons field may be required to be an integer. The table 100 may be provided in any appropriate format used by a third party, such as in a spreadsheet, in an XML data format, in a JSON data format, or in any format that is appropriate for providing the functionality described herein.

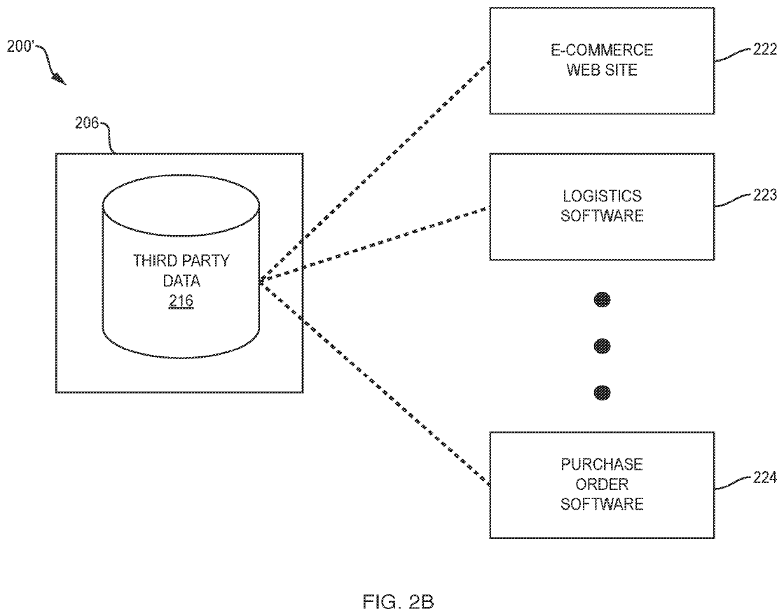

Referring to FIG. 2A, a diagram 200 illustrates relationships between a product vendor 202, an intermediary 204, and a third party 206. The product vendor 202 has product vendor data 212 that corresponds to products provided by the product vendor 202. The product vendor data 212 may be maintained by the product vendor 202 and may contain data that represents attributes for specific products of the product vendor 202. The product vendor data 212 may be maintained in any appropriate format. The intermediary 204 includes intermediary data 214 that corresponds to the product vendor data 212 provided in an intermediary schema. The third party 206 includes third party data 216 that corresponds to a third party schema, such as the table 100, described above. As described in more detail elsewhere herein, the intermediary schema is subsequently mapped to the third party schema for use by the third party 206. If the third party 206 is an e-commerce vendor, for example, then the third party data 216 may be used for one or more Web sites for the e-commerce vendor to sell the products of the product vendor 202 on the Internet. In some cases, the intermediary data 214 may be populated by the product vendor 202 with additional product data that may be over and above data needed by the third party 206, including supplemental product information, marketing descriptions, and additional product imagery.

Referring to FIG. 2B, a diagram 200′ illustrates a number of possibilities for the third party 206 to use the third party data 216. As described elsewhere herein, the third party data 216 may be a schema for an e-commerce Web site 222, a schema for logistics software 223, or a schema for purchase order software 224. Note that the possible uses 212-214 for the third party data 216 shown in the diagram 200′ are only a subset of possibilities and that there are other possible uses for the third party data 216 that are not shown in FIG. 2B.

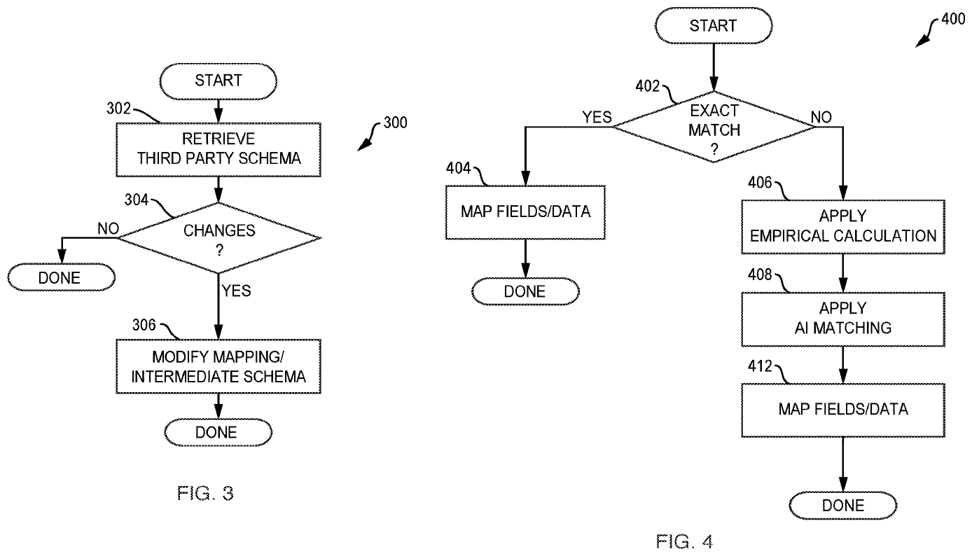

Referring to FIG. 3, a flow diagram 300 illustrates processing performed in connection with periodically adjusting the intermediary schema (intermediary data 214) to reflect changes/additions to the third party schema (third party data 216). As discussed in more detail elsewhere herein, the intermediary schema is mapped to the third party schema. The processing illustrated by the flow diagram 300 handles responding to changes/additions to the third party schema by monitoring and detecting the changes/additions and then, in response thereto, adjusting the intermediary schema and/or adjusting mapping(s) between the intermediary schema and third party schema. The processing illustrated by the flow diagram 300 may be performed periodically where the period is chosen based on a trade-off between overhead associated performing the processing illustrated by the flow diagram 300 and responsiveness to changes in the third party schema. In some embodiments, the processing illustrated by the flow diagram 300 may be invoked manually by a user rather than run periodically.

In an embodiment herein, the vendor product data 212 and/or the intermediary data 214 and/or the third party data 216 is/are stored in a relational database and/or a non-relational database. In some instances, the vendor product data 212 and/or the third party data 216 and/or the intermediary data 214 are stored in a JSON format, which is designed to be linked to a rigid relational schema, for example in a MySQL database. Using the JSON format allows for information to easily be exported and imported into the system in alignment with the database. The JSON format data may integrate with SQL databases and create an ability to define import formats for required information.

Processing for the flow diagram 300 begins at a first step 302 where the system retrieves the third party schema (the third party data 216, described above). Retrieval at the step 302 may use any appropriate mechanism, including API calls, local file access, FTP transfer, etc. Following the step 302 is a test step 304 where it is determined whether, since a previous iteration, the third party schema has changed, which includes, for example, determining whether a new e-commerce vendor has been added and/or whether new fields have been added for an existing vendor and/or whether new requirements have been provided for third party logistics. If not, processing is complete. Note that there is no need to modify the intermediary schema (the intermediary data 214) or modify any mappings if the third party schema has not changed. On the other hand, if it is determined at the test step 304 that the third party schema (the third party data 216) has changed since a previous iteration, then control transfers from the test step 304 to a step 306 where the intermediary schema and/or mappings between the intermediary schema and the third party schema are modified to accommodate the changes to the third party vendor schema. Processing at the step 306 is described in more detail elsewhere herein. Following the step 306, processing is complete.

Referring to FIG. 4, a flow diagram 400 illustrates in more detail processing performed at the step 306 of the flow diagram 300, described above, where the intermediary schema and/or mappings between the intermediary schema and the third party schema are aligned. The processing illustrated by the flow diagram 400 is performed for each new/modified field (i.e., changes or additions to each category/subcategory and corresponding data) of the third party schema. That is, the processing illustrated for the flow diagram 400 is iteratively performed for each modified/new field of the third party schema (the third party data 216).

Processing for the flow diagram 400 begins at a first step 402 where it is determined if the new/modified item (category or subcategory or data) of the third party schema is an exact match of an item (category or subcategory or data) of the intermediary schema. A match occurs when a category/subcategory/data for each is exactly the same. For example, if the third party data is e-commerce data for selling items in the Internet and a category/subcategory of the third party schema is “clothes/price” and a category/subcategory of the intermediary schema is also “clothes/price”, the match is exact. If it is determined at the step 402 that there is an exact match, control transfers from the test step 402 to a step 404 where the category/subcategory of the intermediary schema is mapped to the corresponding category/subcategory of the third party schema. Following the step 404, processing is complete.

If it is determined at the test step 402 that the new/modified item (category or subcategory or data) of the third party schema is not an exact match of an item (category or subcategory or data) of the intermediary schema, then control transfers from the step 402 to a step 406 where empirical calculation is used to determine a best match between a category/subcategory combination and/or corresponding data of the intermediary schema and a category/subcategory combination and/or corresponding data of the third party schema. The empirical calculation at the step 406 also determines an estimate for accuracy of each match. Quantifying match accuracy is based, in part at least, on the mechanism(s) used for empirical matching at the step 406. In an embodiment herein, one or more rules-based algorithms are used at the step 406 to determine a best match and to quantify accuracy of the best match. rules-based algorithms that are used may include a conventional bag-of-words algorithm and a conventional Levenshtein distance algorithm. Of course, other mechanisms/algorithms may be used at the step 406 to determine best matches and accuracy thereof.

Following the step 406 is a step 408 where Artificial Intelligence (AI) is used to determine a best match and an estimate of accuracy thereof between a category/subcategory combination and/or corresponding data of the intermediary schema and a category/subcategory combination and/or corresponding data of the third party schema. The determination at the step 408 may be independent of the determination at the step 406 so that the best match at the step 408 may be the same as or different from the best match determined at the step 406. In an embodiment herein, an AI module uses a TF-IDF (term frequency-inverse document frequency) algorithm to find a best match and to estimate accuracy thereof. TF-IDF algorithms measure a statistical relevance of a word within a collection of other words and documents. The TF-IDF algorithm uses term frequency to recommend matches between a category/subcategory combination and/or corresponding data of the intermediary schema with a category/subcategory combination and/or corresponding data of the e-commerce schema. Of course, other appropriate AI algorithms may be used. Note that, generally, using AI for matching and for training (described elsewhere herein) requires a significant number of calculations per second (e.g., millions per second) to provide useful results in a practical amount of time and that, as the number of fields increases (and thus the number of potential matches increases), the number of calculations required to be performed also increases. Note also that the use of artificial intelligence provides advantages to systems that use empirical calculations alone by providing better matching than empirical calculations in many cases.

The AI algorithm may be trained using previous confirmed mappings between the intermediary schema and the e-commerce schema. Note that, as the number of confirmed mappings increases, the amount of training data for the AI module increases and thus accuracy of the AI module is expected to also increase. Of course, increasing the number of confirmed matches and/or increasing the number of fields also causes the number of calculations to increase so that, in some instances, a training session may require millions of calculations. In some embodiments, the AI algorithm may be tuned/improved by periodically incorporating a training set and then using a separate testing set against the AI algorithm. The period may be once per day. In an embodiment herein, at each period, a first portion (e.g., 80%) of the data for the mappings between the intermediary schema and the third party schema may be used to train the AI algorithm to allow the AI algorithm to learn on new data that has been entered. The accuracy of the AI algorithm may then be validated against the remaining second portion (e.g., 20%) of the data for the mappings between the intermediary schema and the third party schema. The prediction of the AI algorithm may then be compared against actual mappings to see if the AI algorithm was able to return the same result. Periodically training and validating the AI algorithm allows for constant monitoring of the performance of the AI algorithm as new data is provided. The significant training provided to the artificial intelligence system illustrates that using artificial intelligence for matching schema elements may provide advantages over manually matching schema elements since the artificial intelligence may have been trained on thousands or millions of data elements that can be processed rapidly in a way that could not be done by a human.

Following the step 408 is a step 412 where the category/subcategory of the intermediary schema is mapped to the corresponding category/subcategory of the third party schema based on results from the steps 406, 408, described above. In an embodiment herein, mapping at the step 412 is based on whichever match from the steps 406, 408 has a highest estimated accuracy. Thus, for example, if the empirical mapping from the step 406 has an estimated accuracy of 80% and the AI mapping from the step 408 has an estimated accuracy of 90%, then the mapping chosen at the step 412 would be the AI mapping from the step 408. Following the step 412, processing is complete. Note that it is possible to map a single field of the intermediary schema to more than one field of the third party vendor schema and vice versa. Also note that, once the mapping is complete, data may be transferred from the intermediary schema to the third party schema. If the third party is an e-commerce vendor, transferred data may be displayed on a corresponding e-commerce Web site. In some embodiments, a user may need to manually initiate a synchronization to finalize any mapping adjustments and/or to transfer data from the intermediary schema to the third party schema.

In some instances, data values for fields of the third party schema may be restricted to a specific set of particular values. For example, values for a color field may be restricted to specific colors. In instances where data from a field of the third party schema are not identical to data of the intermediary schema, the mapping functionality illustrated by the flow diagram 400 maps data values between mapped fields of the intermediary schema and third party schema. Thus, for example, a color field for a particular product may have a data value of “azure blue” in the intermediary schema that is mapped to a data value of “blue” in a color field of the third party schema. Thus, quantitative and AI mechanisms may be used to map categories and subcategories as well as corresponding data of the intermediary schema and the third party schema.

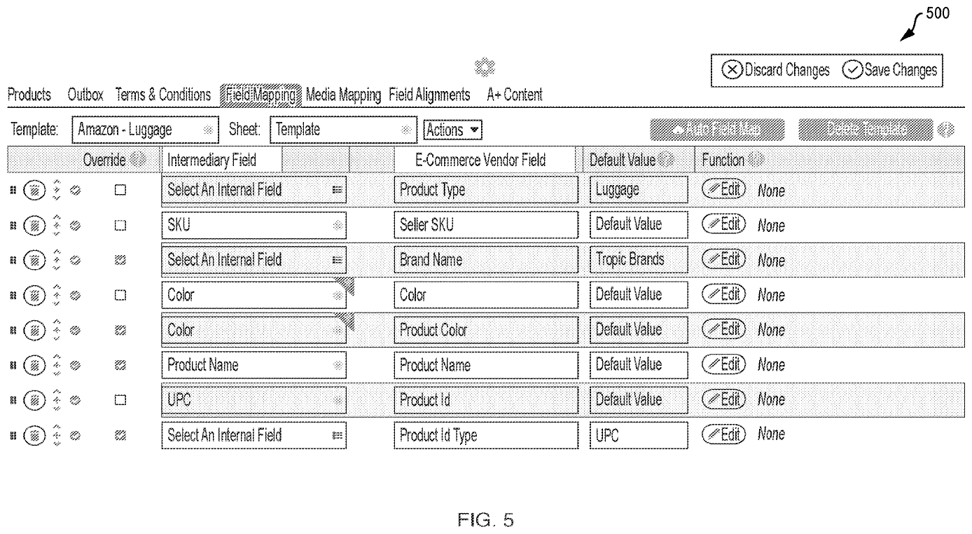

Referring to FIG. 5, a screen 500 may be presented to a user following automated mapping of fields (categories/subcategories) and/or data between the intermediary schema and the third party schema. In the example of FIG. 5, the third party is an e-commerce vendor and the screen 500 shows mappings of product data to e-commerce vendor data. Of course, the invention is not restricted to use only for e-commerce and the third party may correspond to a backend user, a data repository, a mobile application, an enterprise resource planning platform, accounting software, a shipping platform, a logistics platform, purchase order software, etc. When the third party is an e-commerce vendor, the screen 500 essentially presents recommended matches of fields of the intermediary schema and the e-commerce vendor schema. In some embodiments, it may be useful to provide a user with an opportunity to confirm/modify any recommended automated mappings that have been performed. The screen 500 illustrates mappings between fields (categories/subcategories) of the intermediary schema and fields of the e-commerce vendor schema, but of course the same mechanism is also applicable to data value mappings (e.g., mapping “azure blue” to “blue” for a color subcategory). The screen 500 provides controls for the user to verify or override each of the automated mappings.

The user may also have an opportunity to add a new field (category/subcategory) or a new data value in instances where none of the fields of the intermediary schema properly match a field of the e-commerce vendor schema. Thus, if a best match determined by the processing illustrated in connection with the flow diagram 400 is inadequate, a user may use the controls to add a new field (category/subcategory) or a new data value to the intermediary schema to provide an appropriate match. Note that it is also possible for the screen to provide a recommendation to a user to add a new field to the intermediary schema if the automated system is unable to recommend an adequate match (or any match) of a field of the third party schema to an existing field of the intermediary schema. In some cases, the screen 500 and corresponding controls may be adapted to allow a user to manually enter new schema information and mappings therefor. A user manually entering new mappings may specify the particular third party (e.g., particular e-commerce vendor) for the new mappings.

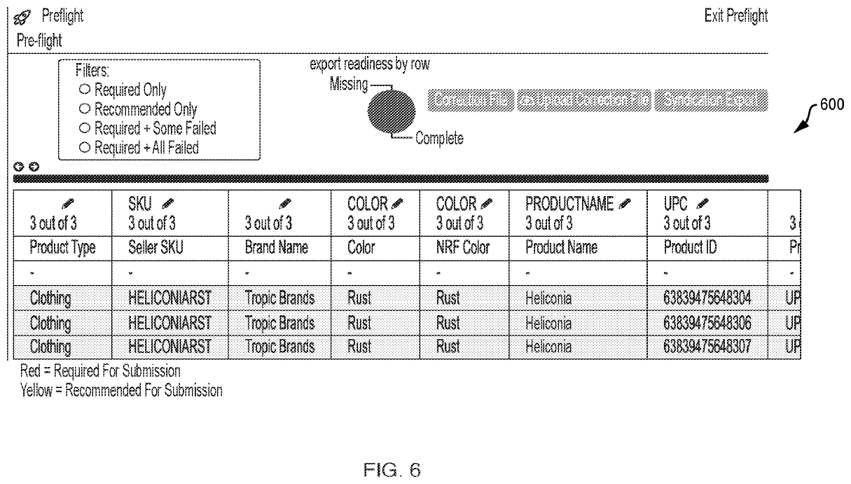

Referring to FIG. 6, a screen 600 illustrates a preflight data view for previewing data for a third party that has been mapped from an intermediary schema, as described elsewhere herein. The example of FIG. 6, like FIG. 5, illustrates the third party being an e-commerce vendor, but the invention is not so restricted. The screen 600 indicates any data that may be missing as well as showing data that will be provided for the schema of the e-commerce vendor. The preflight data view can be useful in many instances, including instances where a single intermediary schema for a product vendor is used to populate multiple e-commerce Web sites for different e-commerce vendors. Note that for an intermediary schema, it is possible for the mappings to be sufficient for one third party (e.g., one particular e-commerce vendor) but not for another. The preflight data view may be useful for detecting such a situation before attempting to present vendor products on an e-commerce Web site.

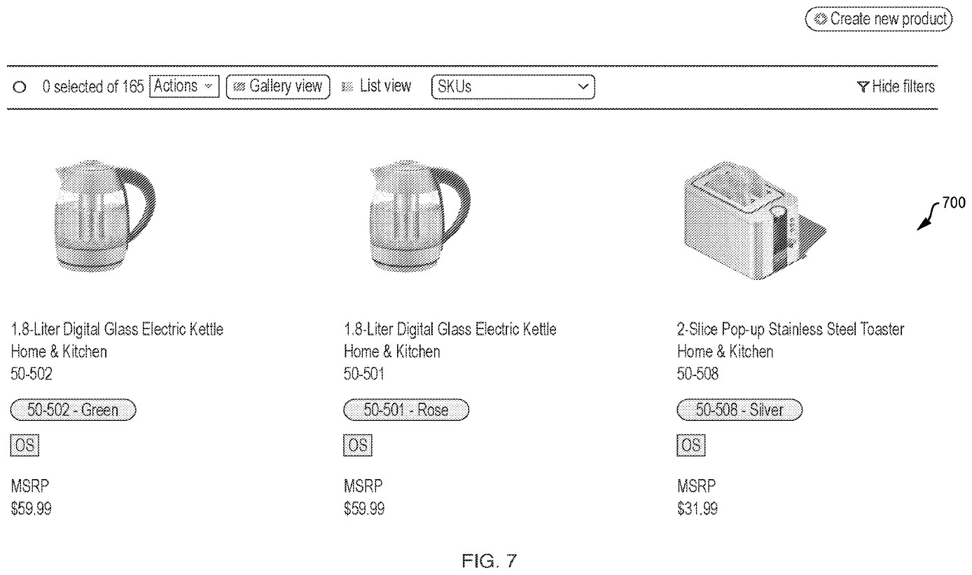

Referring to FIG. 7, a screen 700 illustrates a view of products on an e-commerce vendor Web site based on data in the e-commerce vendor schema. The information presented on the screen 700 corresponds to data from the intermediary schema that is mapped to an e-commerce vendor schema. In some embodiments, a user may be provided with a mockup of the screen 700 prior to confirming alignment of schemas in order to verify that the products will appear correctly on the e-commerce vendor Web site. Thus, viewing a mockup may be useful to ensure correctness of data mapped from the intermediary schema to the e-commerce vendor schema prior to deployment.

In some embodiments, it is possible to export data corresponding to the intermediary schema and mapping information. The exported data may be a JSON definition file that contains any updates made to the intermediary schema, as well as any updates to e-commerce vendor schemas and mappings. The exported data may be used for change management or archival purposes. The exported data may also be used to test changes in one software environment before deploying/promoting the changes to another software environment. The exported data may also be used to keep multiple instances of software in lockstep where the intermediary schema has been deployed in multiple active software applications. It may also be possible to load exported data to update an intermediary schema and mappings.

As discussed elsewhere herein, the invention is not confined to utilization regarding e-commerce but can similarly be utilized for alignment of media content (i.e. content imagery, video, enhanced content) between external sources. For example, linkages and schema can also be applied to align images and other visual content to group all information about a product (images background, size, pixel count, computer vision to map and reverse define requirements for product content). The system described herein allows for reverse engineering of product content to be derived as a result of applying artificial intelligence against media to produce product attributes such as color, product type, materials composition, and many additional attributes to be stored within an internal schema, such as the intermediary schema described elsewhere herein. The invention may be used with any third party having a third party schema containing product data, such as backend users, data repositories, mobile applications, enterprise resource planning platforms, accounting software, shipping platforms, logistics platforms, purchase order software, etc.

Software implementations of the system described herein may include executable code that is stored in a non-transitory computer-readable medium and executed by one or more processors. The computer-readable medium may include volatile memory and/or non-volatile memory, and may include, for example, a computer hard drive, ROM, RAM, flash memory, portable computer storage media such as a CD-ROM, a DVD-ROM, an SD card, a flash drive or other drive with, for example, a universal serial bus (USB) interface, and/or any other appropriate tangible or non-transitory computer-readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of transferring product data to a third party, comprising:
obtaining modifications to a schema of the third party;
adjusting mappings between the schema of the third party data and an intermediary schema containing data corresponding to the product data based on the modifications by first matching fields of the intermediary schema with fields of the third party schema that are an exact match and then, for remaining unmatched fields of the third party schema, determining a best match between fields of the intermediary schema and the third party schema and estimating an accuracy of the best match using empirical calculations and an artificial intelligence algorithm and choosing a mapping having a highest estimate of accuracy; and
providing data from the intermediary schema to the third party schema according to the mappings following adjusting the mappings.

2. The method of claim 1, wherein the empirical calculations use at least one rules-based algorithm to find a best match between fields of the intermediary schema and fields of the third party schema and to estimate an accuracy thereof.

3. The method of claim 2, wherein the at least one rules-based algorithm is at least one of: a bag-of-words algorithm or a Levenshtein distance algorithm.

4. The method of claim 2, wherein the artificial intelligence algorithm uses a term frequency-inverse document frequency algorithm to find the best match between fields of the intermediary schema and fields of the third party schema and to estimate the accuracy of the best match.

5. The method of claim 1, further comprising:
prior to providing the data from the intermediary schema to the third party schema, presenting a user with a screen indicating the mappings.

6. The method of claim 5, wherein the screen includes controls that allow the user to change the mappings.

7. The method of claim 6, wherein the user uses the controls to approve or reject suggested mappings provided on the screen.

8. The method of claim 6, wherein the user is provided with a recommendation to add at least one new field to the intermediary schema that is mapped to a field of the third party schema.

9. The method of claim 6, wherein the user uses the controls on the screen to enter new schema information and mappings therefor.

10. The method of claim 1, further comprising:
after providing the data from the intermediary schema to the third party schema, presenting the user with a screen indicating any data that may be missing and showing data that is to be provided for the third party schema.

11. The method of claim 1, wherein previously confirmed mappings are used to train the artificial intelligence algorithm.

12. The method of claim 11, wherein the artificial intelligence algorithm is trained periodically.

13. The method of claim 11, wherein a first portion of data corresponding to the confirmed mappings is used to train the artificial intelligence algorithm and a second, remaining, portion of the data corresponding to the confirmed mappings is used to validate the artificial intelligence algorithm.

14. The method of claim 13, wherein the first portion is 80% and the second portion is 20%.

15. The method of claim 1, further comprising:
after providing the data from the intermediary schema to the third party schema, exporting data corresponding to the intermediary schema and mapping information.

16. The method of claim 15, wherein data that is exported is provided in a JSON format.

17. The method of claim 15, wherein data that is exported provides audit information.

18. The method of claim 1, wherein the third party is an e-commerce vendor and wherein data that is provided from the intermediary schema to the third party schema is displayed on a Web site of the e-commerce vendor.

19. A non-transitory computer readable medium containing software that transfers product data to a third party, the software comprising:
executable code that obtains modifications to a schema of the third party;
executable code that adjusts mappings between the schema of the third party data and an intermediary schema containing data corresponding to the product data based on the modifications by first matching fields of the intermediary schema with fields of the third party schema that are an exact match and then, for remaining unmatched fields of the third party schema, determining a best match between fields of the intermediary schema and the third party schema and estimating an accuracy of the best match using empirical calculations and an artificial intelligence algorithm and choosing a mapping having a highest estimate of accuracy; and
executable code that provides data from the intermediary schema to the third party schema according to the mappings following adjusting the mappings.

20. The non-transitory computer readable medium of claim 19, wherein the third party is an e-commerce vendor and wherein data that is provided from the intermediary schema to the third party schema is displayed on a Web site of the e-commerce vendor.
